(19) United States
(12) Patent Application Publication
(10) Pub. No.: US 2025/0365350 A1
(43) Pub. Date: Nov. 27, 2025

(54) IN-NETWORK COMPUTING USING MODULAR SWITCH ARCHITECTURE

(71) Applicant: Cisco Technology, Inc., San Jose, CA (US)

(72) Inventor: Harsha Bharadwaj, BANGALORE (IN)

(21) Appl. No.: 18/674,640

(22) Filed: May 24, 2024

(51) Int. Cl. H04L 69/04; H04L 49/15; H04L 49/90

(52) U.S. Cl. CPC H04L 69/04; H04L 49/15; H04L 49/90

(57) ABSTRACT

Devices, systems, methods, and processes for in-network computing using modular switch architecture are described herein. Endpoint devices generate data chunks and forward them to a network, comprising spine and leaf switches, for data reduction. Leaf switches act as conduits and forward the data chunks to a spine switch. The spine switch includes various line cards (e.g., one for each leaf switch) and a fabric element. The line cards may execute a stage of data reduction on the received data chunks or may forward the received data chunks directly to the fabric element. The fabric element executes a data reduction operation on the data received from the line cards and obtains a reduced output which is forwarded to the endpoint devices via the line cards and the leaf switches. Thus, a single-tier in-network computing topology is implemented to execute data reduction in a cost-effective, simple, and efficient manner.

The present disclosure relates to communications. More particularly, the present disclosure relates to in-network computing using modular switch architecture.

### BACKGROUND

In the domain of high-performance computing, managing extensive datasets poses a substantial obstacle. One strategy to expedite tasks involves distributing computations across multiple graphics processing units (“GPUs”). However, in such scenarios, the data frequently exceeds the memory capacity of a single GPU. To address this challenge, both data and computations are spread across multiple GPUs, and an efficient interconnection between GPUs via a high-speed network is established. In-network computing (“INC”) emerges as a crucial optimization technique designed to alleviate inter-GPU traffic (e.g., data movement or data reduction collectives) through network offloads. INC leverages the inherent broadcast/multicast capabilities of a network to refine data movement between GPUs and computation elements within network switches. This approach reduces the volume of data traversing the network, thereby demanding less network bandwidth. Additionally, it diminishes the latency for completing collective operations, resulting in faster overall completion times.

In a typical network topology, GPUs are coupled to various leaf switches which are in turn coupled to various spine switches. Data is transferred between a GPU's network interface controller (“NIC”) and an NIC (e.g., a logical NIC) of a leaf switch, and also between NICs of leaf and spine switches. These switches inherently support unicast, broadcast, and multicast, allowing them to readily accommodate data movement collective offloads, as these operations primarily involve data transfer. However, enabling support for data reduction collectives necessitates switches with the capability to interpret and compute the data before its transmission. This requires additional hardware functionalities that are not typically inherent in switches. Switches supporting INC data reduction require a memory and computational elements (such as arithmetic logic units) to facilitate reduction operations. Generally, three levels of INC reduction are achievable with data reduction collectives. At the first level, the NIC of the GPU can perform reduction operations within the GPU. At the second level, a leaf switch can execute reduction operations across all the GPU NICs coupled to it. Lastly, a spine switch can conduct reduction operations across all the leaf switches coupled to it.

The implementation of multi-layer INC reduction in switches can encounter several challenges. Leaf switches are typically lower-cost switches with limited resources and power budget. Also, the leaf switches implement most of the features-related switching functions, resulting in higher design complexity. Hence, the leaf switches may find it impractical to add additional hardware such as memory or arithmetic logic units to support reduction operations. Employing a multi-tier topology introduces complexities in INC tree management, leading to intricate error recovery scenarios and more challenging troubleshooting. Additionally, utilizing leaf switches for reduction necessitates setting up separate forwarding rules for INC reduction collectives, potentially causing congestion for other traffic as the reduction tree may dictate a fixed packet path regardless of congestion levels.

### SUMMARY OF THE DISCLOSURE

Systems and methods for in-network computing using modular switch architecture in accordance with embodiments of the disclosure are described herein. In many embodiments, a device includes a processor, a memory communicatively coupled to the processor, a plurality of line cards, and a fabric element coupled to the plurality of line cards. One or more line cards of the plurality of line cards are configured to receive a plurality of data chunks, execute a first stage of data reduction on the plurality of data chunks, and obtain one or more first reduced outputs based on the execution of the first stage of data reduction. The fabric element is configured to receive the one or more first reduced outputs, execute a second stage of data reduction on the one or more first reduced outputs, obtain a second reduced output based on the execution of the second stage of data reduction, and forward the second reduced output.

In a number of embodiments, the plurality of data chunks are received from a set of network devices.

In a variety of embodiments, the one or more line cards are further configured to receive a plurality of start messages from the set of network devices.

In numerous embodiments, the plurality of start messages are configured to signal a forthcoming arrival of the plurality of data chunks.

In more embodiments, the one or more line cards are further configured to receive a plurality of end messages from the set of network devices.

In some more embodiments, the plurality of end messages are received subsequent to receiving the plurality of data chunks.

In still more embodiments, the plurality of end messages are configured to signal a completion of data reception.

In yet more embodiments, the plurality of data chunks are received from the set of network devices via one or more leaf switches.

In still yet more embodiments, the plurality of line cards are coupled to a set of leaf switches.

In additional embodiments, the plurality of line cards are coupled to the set of leaf switches on a one-to-one basis.

In further embodiments, the device operates as a root member of a reduction tree in a single-tier in-network computing topology.

In further additional embodiments, a line card of the plurality of line cards is configured to simulate a network interface controller to provide access to a network.

In numerous additional embodiments, at least one of the plurality of line cards or the fabric element is configured to advertise a capability parameter associated with at least one of the plurality of line cards or the fabric element.

In several embodiments, a device includes a processor, a memory communicatively coupled to the processor, a plurality of line cards, and a fabric element coupled to the plurality of line cards. One or more line cards of the plurality of line cards are configured to receive a plurality of data chunks and forward the plurality of data chunks. The fabric element is configured to receive, from the one or more line cards, the plurality of data chunks, execute a data reduction operation on the plurality of data chunks, obtain a reduced output based on the execution of the data reduction operation, and forward the reduced output.

In several more embodiments, the fabric element is further configured to execute a data buffering operation until data reception from a set of network devices is complete.

In still further embodiments, the one or more line cards are further configured to receive a plurality of end messages from the set of network devices subsequent to receiving the plurality of data chunks.

In still additional embodiments, the completion of the data reception is signaled to the fabric element by the plurality of end messages.

In many further embodiments, a method includes receiving a plurality of data chunks, executing a first stage of data reduction on the plurality of data chunks to obtain one or more first reduced outputs, executing a second stage of data reduction on the one or more first reduced outputs to obtain a second reduced output, and forwarding the second reduced output.

In still yet additional, the first stage of data reduction and the second stage of data reduction are executed in a modular spine switch.

In still yet further, the modular spine switch is a root member of a reduction tree in a single-tier in-network computing topology.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of an example architecture for a network fabric in accordance with various embodiments of the disclosure;

FIG. 2 is a schematic block diagram of an example computing system that employs single-tier in-network computing in accordance with various embodiments of the disclosure;

FIG. 3 is a schematic block diagram of an example computing system that illustrates a logical topology of single-tier in-network computing in accordance with various embodiments of the disclosure;

FIG. 4 is a schematic block diagram of a spine switch in accordance with various embodiments of the disclosure;

FIG. 5 is a flowchart depicting a process for implementing a non-repeatable reduction operation in single-tier in-network computing in accordance with various embodiments of the disclosure;

FIG. 6 is a flowchart depicting a process for implementing a repeatable reduction operation in single-tier in-network computing in accordance with various embodiments of the disclosure;

FIG. 7 is a flowchart depicting a process for implementing a reduction operation in a spine switch in accordance with various embodiments of the disclosure; and

FIG. 8 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that facilitate single-tier in-network computing (“INC”). In many embodiments, a spine switch may be coupled to multiple leaf switches and each leaf switch may be coupled to multiple endpoint devices (e.g., graphics processing units also referred to as “GPUs”). The single-tier INC involves reduction exclusively at the spine layer of the network. In other words, the leaf switches act as mere conduits for data transfer, with no data reduction functionality.

In a number of embodiments, a spine switch may include a fabric element coupled to various line cards. Further, the line cards may be coupled to the leaf switches on a one-to-one basis. The modular architecture of the spine switch enables the single-tier INC implementation. In a variety of embodiments, the fabric element may be designed to handle large volumes of data traffic efficiently and reliably, often utilizing high-speed interfaces and specialized networking protocols optimized for the particular requirements of the network fabric. In numerous embodiments, a line card refers to a modular hardware component of the spine switch. The line card is responsible for handling the input and output of data packets as they pass through the spine switch. The line card may simulate a network interface controller (“NIC”) to provide access to a network. The line cards and the fabric element enable the repeatable and non-repeatable data reduction operations to be executed exclusively at the spine switch, thereby implementing the single-tier INC.

In additional embodiments, every endpoint device chunks the data for the collective into a predetermined chunk size and forwards the data chunks for data reduction collectives in the network. In further embodiments, for non-repeatable reduction operations, the line cards may receive a plurality of data chunks from a set of network devices via the leaf switches. In still more embodiments, the line cards may receive a plurality of start messages from the set of network devices, with the plurality of start messages signaling a forthcoming arrival of the plurality of data chunks. In still further embodiments, the line cards may execute a first stage of data reduction on the plurality of data chunks and obtain one or more first reduced outputs. The fabric element may receive the one or more first reduced outputs from the line cards, execute a second stage of data reduction on the one or more first reduced outputs, and obtain a second reduced output. The non-repeatable data reduction operations are thus executed. In still additional embodiments, the fabric element may forward the second reduced output to destination endpoint devices by way of any line card and leaf switch. In the present disclosure, the spine switch thus operates as a root member of a reduction tree in a single-tier INC topology.

In some more embodiments, for repeatable reduction operations, the line cards may receive the plurality of data chunks from the set of network devices via the leaf switches and forward the plurality of data chunks to the fabric element. Repeatable reduction operations must produce consistent results on every execution, requiring a strict execution order. In the network, the time at which the data chunks may arrive from each endpoint device is not deterministic. Thus, to establish a fixed execution order, data may need to be cached or collected until all participating endpoint devices contribute their data, after which reduction occurs in a predetermined order. Thus, in the present disclosure, the fabric element may be configured to execute a data buffering operation until data reception from the set of network devices is complete. In more embodiments, the fabric element may be associated with a buffer to collect and buffer data received from each endpoint device. The line cards may receive a plurality of end messages from the set of network devices subsequent to receiving the plurality of data chunks. The completion of the data reception is signaled to the fabric element by the plurality of end messages. The fabric element may then execute a data reduction operation on the plurality of data chunks. In other words, the fabric element may execute the data reduction operation upon the reception of the plurality of end messages. The data reduction operation may be executed in the predetermined order. Based on the execution of the data reduction operation, the fabric element may obtain a reduced output. The fabric element may forward the reduced output to the destination endpoint devices of the data reduction collectives.

In numerous additional embodiments, the INC hardware components (e.g., memory, arithmetic logic units, or the like) are placed in a distributed fashion in every line card of the spine switch to perform reduction locally in every line card. During the data reduction phase, the line cards perform the first stage of reduction. This way all the reduction data that would have conventionally been done by a leaf switch, if it were reduction capable, is now done by the corresponding spine switch line card connected to that specific leaf switch. As a result, the reduction of data from all endpoint devices coupled to one leaf switch is being executed by a line card coupled to that leaf switch. Thus, the INC function that would have happened on a leaf switch is offloaded to the corresponding line card of the spine switch.

In yet more embodiments, the line cards and/or the fabric element may advertise a capability parameter. The amount of data that can be reduced is the capability parameter that is advertised to an aggregation manager associated with the single-tier INC topology. The INC data reduction in the spine switch is executed if the data being reduced is less than or equal to the capability parameter. Conversely, if the data being reduced is more than the capability parameter, the aggregation manager may reject the collective operation, and the line cards may forward, via the leaf switches, the plurality of data chunks to the corresponding destination endpoint devices without reduction. The endpoint devices may thus have to fallback to a non-INC method of reduction using the GPU compute and using the regular GPU to GPU communication with the switches just acting like data conduits.

In numerous additional embodiments, the fabric element may advertise a repeatable reduction capacity. The amount of data that can be buffered (e.g., cached) in the spine switch is the repeatable reduction capacity that is advertised to the aggregation manager. The repeatable reductions in the spine switch are executed if the data being buffered is less than or equal to the repeatable reduction capacity. Conversely, if the data being buffered is more than the repeatable reduction capacity, the aggregation manager may reject the collective operation, and the line cards may forward, via the leaf switches, the plurality of data chunks to the corresponding destination endpoint devices without reduction. The endpoint devices may thus have to fallback to a non-INC method of reduction using the GPU compute and using the regular GPU to GPU communication with the switches just acting like data conduits.

The present disclosure facilitates a methodology where the reduction operation is executed exclusively in a spine switch. This is in contrast to conventional INC operations where the data reduction was executed in both leaf and spine switches. Thus, in the present disclosure, to support INC, the leaf switches are not required to undergo any changes and exclusively a few spine switches are updated with the necessary hardware. The same architecture provides support for both repeatable and non-repeatable collective operations. In the present disclosure, the operations of the aggregation manager are simplified as the aggregation manager only deals with the switches in the spine layer. A single-layer INC topology is easy to maintain and troubleshoot, with a simpler error recovery as compared to conventional INC implementations. Spine switches have higher power, real estate, and cost budget, and lesser switching function complexity, and hence, can absorb the additional INC hardware components with minimal overall impact. The modular spine switches are built for redundancy with dual switch components and no single point of failure. Hence, despite having a single-tier topology, the INC reduction tree is resilient to failures and has high availability. Additionally, as leaf switches are not utilized for reduction, the need to set up separate forwarding rules for INC reduction collectives is eliminated. Further, INC executed centrally (e.g., at the spine switch) conserves the overall memory required for the implementation.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (“PCB”) or the like. Each of the functions and/or modules described herein, in numerous additional embodiments, may alternatively be embodied by or implemented as a component.

A circuit, as used herein, comprises a set of one or more electrical and/or electronic components providing one or more pathways for electrical current. In numerous additional embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board, or the like. Each of the functions and/or modules described herein, in numerous additional embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

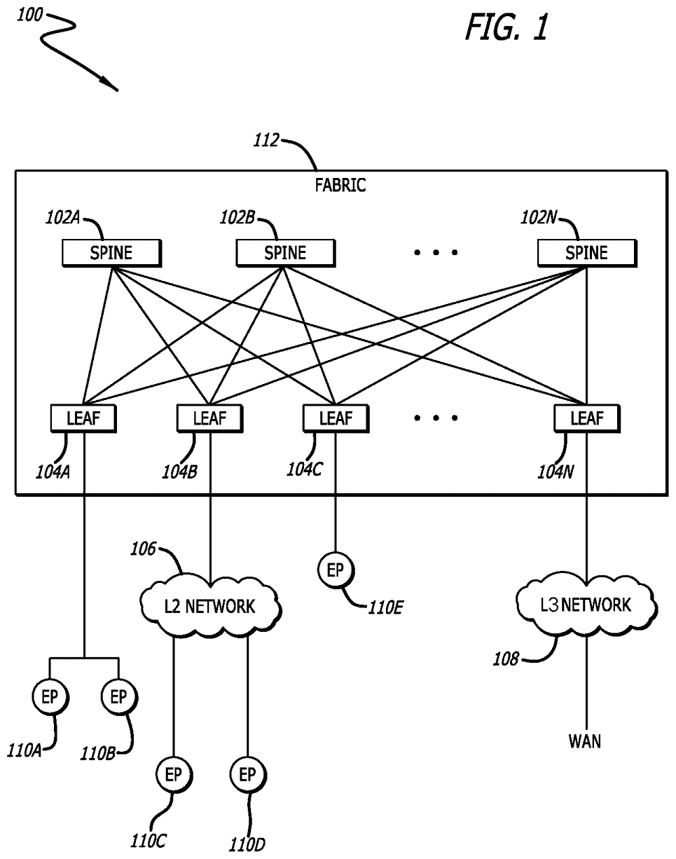

Referring to FIG. 1, a schematic block diagram of an example architecture 100 for a network fabric 112 in accordance with various embodiments of the disclosure is shown. The network fabric 112 can include spine switches 102A, 102B, . . . 102N (collectively “102”) connected to leaf switches 104A, 104B, 104C, . . . 104N (collectively “104”) in the network fabric 112. As those skilled in the art will recognize, networking fabric can refer to a high-speed, high-bandwidth interconnect system that enables multiple devices to communicate with each other efficiently and reliably. It is a network topology that is designed to provide a flexible and scalable infrastructure for data centers, cloud environments, and other network elements.

Various embodiments described herein can include a leaf-spine architecture comprising a plurality of spine switches and leaf switches. Spine switches 102 can be L3 switches in the fabric 112. An L3 switch, or Layer 3 switch, is a networking device that operates at a network layer (Layer 3) of the Open Systems Interconnection (“OSI”) model. However, in some cases, the spine switches 102 can also, or otherwise, perform L2 (e.g., Layer 2 of the OSI model) functionalities. Further, the spine switches 102 can support various capabilities, such as, but not limited to, 400 or 800 gigabit per second (“Gbps”) Ethernet speeds. To this end, the spine switches 102 can be configured with one or more 800 Gigabit Ethernet ports. In numerous additional embodiments, each port can also be split to support other speeds. For example, an 800 Gigabit Ethernet port can be split into two 400 Gigabit Ethernet ports, although a variety of other combinations are available.

In many embodiments, one or more of the spine switches 102 can be configured to host a proxy function that performs a lookup of the endpoint address identifier to locator mapping in a mapping database on behalf of the leaf switches 104 that do not have such mapping. The proxy function can do this by parsing through the packet to the encapsulated tenant packet to get to the destination locator address of the tenant. The spine switches 102 can then perform a lookup of their local mapping database to determine the correct locator address of the packet and forward the packet to the locator address without changing certain fields in the header of the packet.

In various embodiments, when a packet is received at a spine switch 102ᵢ, where subscript “i” indicates that this operation may occur at any spine switch 102A to 102N, the spine switch 102ᵢ can first check if the destination locator address is a proxy address. If so, the spine switch 102ᵢ can perform the proxy function as previously mentioned. If not, the spine switch 102ᵢ can look up the locator in its forwarding table and forward the packet accordingly.

In a number of embodiments, one or more spine switches 102 can connect to one or more leaf switches 104 within the fabric 112. The leaf switches 104 can include access ports (or non-fabric ports) and fabric ports. Fabric ports can provide uplinks to the spine switches 102, while access ports can provide connectivity for devices, hosts, endpoints, virtual machines (“VMs”), or external networks to the fabric 112.

In more embodiments, the leaf switches 104 can reside at the edge of the fabric 112, and can thus represent the physical network edge. In some cases, the leaf switches 104 can be top-of-rack (“ToR”) switches configured according to a ToR architecture. In other cases, the leaf switches 104 can be aggregation switches in any particular topology, such as end-of-row (“EoR”) or middle-of-row (“MoR”) topologies. The leaf switches 104 can also represent aggregation switches, for example.

In additional embodiments, the leaf switches 104 can be responsible for routing and/or bridging various packets and applying network policies. In some cases, a leaf switch can perform one or more additional functions, such as implementing a mapping cache, sending packets to the proxy function when there is a miss in the cache, encapsulating packets, enforcing ingress or egress policies, etc. Moreover, the leaf switches 104 can contain virtual switching functionalities, such as a virtual tunnel endpoint (“VTEP”) function. Further, the leaf switches 104 can connect the fabric 112 to an overlay network.

In further embodiments, network connectivity in the fabric 112 can flow through the leaf switches 104. Here, the leaf switches 104 can provide servers, resources, endpoints, external networks, or VMs access to the fabric 112, and can connect the leaf switches 104 to each other. In some cases, the leaf switches 104 can connect endpoint groups to the fabric 112 and/or any external networks. Each endpoint group can connect to the fabric 112 via one of the leaf switches 104, for example.

Endpoints 110A-110E (collectively “110”, shown as “EP”) can connect to the fabric 112 via the leaf switches 104. For example, the endpoints 110A and 110B can connect directly to the leaf switch 104A, which can connect the endpoints 110A and 110B to the fabric 112 and/or any other one of the leaf switches 104. Similarly, the endpoint 110E can connect directly to the leaf switch 104C, which can connect the endpoint 110E to the fabric 112 and/or any other of the leaf switches 104. On the other hand, the endpoints 110C and 110D can connect to the leaf switch 104B via L2 network 106. Similarly, the wide area network can connect to the leaf switch 104N via L3 network 108.

In numerous additional embodiments, the endpoints 110 can include any communication devices, such as computers, servers, switches, routers, graphics processing units (“GPUs”), etc. In some cases, the endpoints 110 can include a server, hypervisor, or switch configured with a VTEP functionality which connects an overlay network with the fabric 112. The overlay network can host physical devices, such as servers, applications, endpoint groups, virtual segments, virtual workloads, etc. In addition, the endpoints 110 can host virtual workload(s), clusters, and applications or services, which can connect with the fabric 112 or any other device or network, including an external network. For example, one or more of the endpoints 110 can host, or connect to, a cluster of load balancers or an endpoint group of various applications.

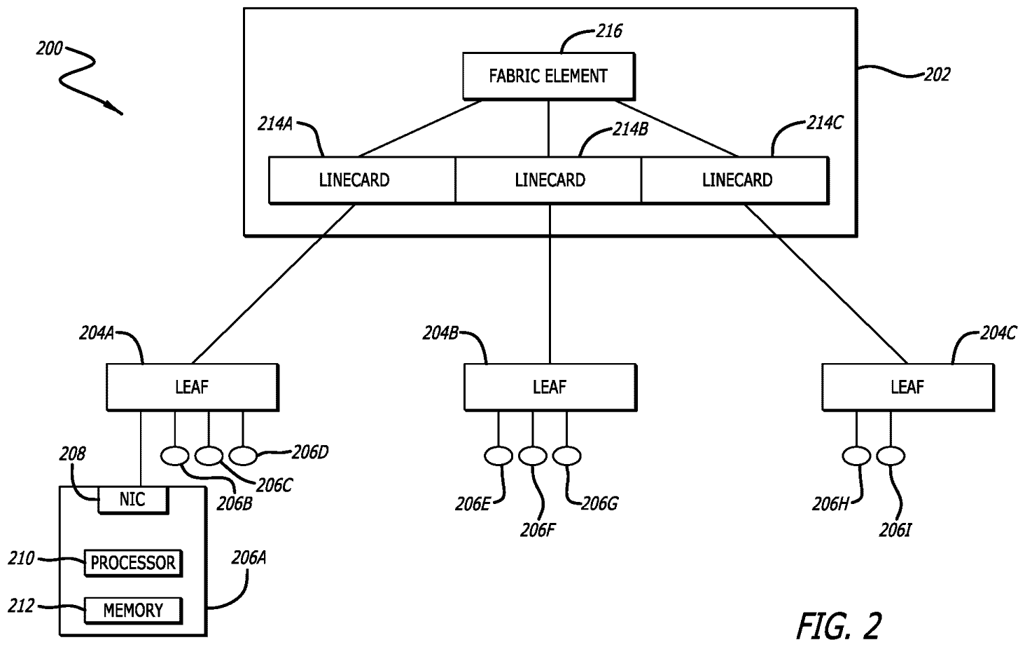

Although a specific embodiment for an architecture 100 is described above with respect to FIG. 1, any of a variety of systems and/or processes may be utilized in accordance with embodiments of the disclosure. For example, the architecture 100 could comprise any variety of endpoints, spine switches, and/or leaf switches. The elements depicted in FIG. 1 may also be interchangeable with other elements of FIGS. 2-8 as required to realize a particularly desired embodiment.

Referring to FIG. 2, a schematic block diagram of an example computing system 200 that employs single-tier in-network computing (“INC”) in accordance with various embodiments of the disclosure is shown. The computing system 200 may be used in various applications, such as, for example, data centers, systems providing cloud services, high-performance computing and distributed computing, or the like.

The embodiments depicted in FIG. 2 may show the computing system 200 including a spine switch 202 coupled to first through third leaf switches 204A-204C (collectively “leaf switches 204”). The computing system 200 may further include first through ninth endpoint devices 206A-206I (collectively “endpoint devices 206”). The first through fourth endpoint devices 206A-206D are coupled to the first leaf switch 204A, the fifth through seventh endpoint devices 206E-206G are coupled to the second leaf switch 204B, and the eighth and ninth endpoint devices 206H and 206I are coupled to the third leaf switch 204C.

As those skilled in the art will recognize, the spine switch 202 and the leaf switches 204 can form a high-speed, high-bandwidth interconnect system that enables multiple devices (e.g., the endpoint devices 206) to communicate with each other efficiently and reliably. For example, the spine switch 202 and the leaf switches 204 may form a network based on Remote Direct Memory Access (“RDMA”) based protocol, for example, an RDMA over Converged Ethernet version 2 (“RoCEv2”) protocol. Further, the network may utilize the RDMA-based protocol in a reliable connection (“RC”) mode.

In many embodiments, the spine switch 202 is a network device that interconnects and facilitates communication between the leaf switches 204. The spine switch 202 may be configured to route traffic between the different leaf switches 204. In some examples, the spine switch 202 can be L3 switches. In a variety of embodiments, the leaf switches 204 are network devices that represent physical network edges. In some examples, the leaf switches 204 can be ToR switches configured according to a ToR architecture. In other examples, the leaf switches 204 can be aggregation switches in any particular topology, such as EoR or MoR topologies. The leaf switches 204 may be configured to serve as connection points for the endpoint devices 206. Further, the leaf switches 204 may be configured to aggregate traffic from the endpoint devices 206 and forward it to the spine switch 202. The leaf switches 204 can function as ingress and egress switches. The leaf switches 204 may not be directly coupled to each other but can be coupled indirectly through the spine switch 202. In some examples, a number of uplinks from a leaf switch is equal to a number of spine switches, and a number of downlinks from a spine switch is equal to the number of leaf switches.

The endpoint devices 206 can include any communication devices, such as computers, servers, switches, routers, GPUs, etc. In some cases, the endpoint devices 206 can include a server, hypervisor, or switch configured with a VTEP functionality which connects an overlay network with a fabric (e.g., the spine switch 202 and the leaf switches 204). The overlay network can host physical devices, such as servers, applications, endpoint groups, virtual segments, virtual workloads, etc. In addition, the endpoint devices 206 can host virtual workload(s), clusters, and applications or services, which can connect with the fabric or any other device or network, including an external network. For example, one or more of the endpoint devices 206 can host, or connect to, a cluster of load balancers or an endpoint group of various applications. Endpoint devices (such as the endpoint devices 206) that want to perform a collective operation, create and join a group, with every endpoint device being assigned a unique ID.

In numerous embodiments, an endpoint device 206ᵢ may comprise a network interface controller (“NIC”) 208, a processor 210, and a memory 212 coupled to each other via a communication bus. Here, subscript “i” indicates that this configuration can be present in any of the endpoint devices 206A-206I. In FIG. 2, an exploded view of only one endpoint device 206A is shown for illustrative purposes.

The NIC 208 may include a gigabit Ethernet adapter or any similar component that may couple the endpoint device 206ᵢ to other devices, for example, one of the leaf switches 204. The NIC 208 can provide the necessary interface (e.g., input ports and output ports) to couple the endpoint device 206ᵢ to one of the leaf switches 204. The NIC 208 can be configured to handle the transmission and reception of packets, implementing protocols such as the RoCEv2 protocol to ensure compatibility and interoperability within the network. In more embodiments, the NIC 208 can perform reduction operations within the endpoint device 206ᵢ.

The processor 210 may include any suitable type of processor or a Central Processing Unit (“CPU”). The processor 210 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units (“ALUs”), floating-point units, and the like.

The memory 212 may reside within or externally to the endpoint device 206ᵢ and may include any suitable type of memory implemented using any suitable storage technology. For example, the memory 212 may comprise a Random Access Memory (“RAM”), a Nonvolatile Memory (“NVM”), or a combination of a RAM and an NVM. The memory 212 may include instructions to be performed by the processor 210.

INC is a crucial optimization technique designed to alleviate inter-GPU traffic through network offloads. The inter-GPU traffic may correspond to data movement collectives and/or data reduction collectives. In INC, inherent broadcast/multicast capabilities of a network are leveraged to refine data movement between endpoint devices and computation elements within network switches, facilitating data reduction operations on collectives. As a result, the volume of data traversing the network is reduced, thereby demanding less network bandwidth. Additionally, it diminishes the latency for completing collective operations, resulting in faster overall completion times. In a typical network topology, endpoint devices (such as GPUs) are coupled to leaf switches, and the leaf switches are coupled to spine switches. Data is transferred between a GPU's NIC and an NIC (e.g., a logical NIC) of a leaf switch, and also between NICs of leaf and spine switches. These switches inherently support unicast, broadcast, and multicast, allowing them to readily accommodate data movement collective offloads, as these operations primarily involve data transfer. The switches can thus be set up for performing data movement collectives like AllGather, AlltoAll, Scatter, Gather, or the like.

However, enabling support for data reduction collectives (such as Reduce, All-Reduce, or similar operations) necessitates switches with the capability to interpret and compute the data before its transmission. This requires additional hardware functionalities that are not typically inherent in switches. Switches supporting INC data reduction require NICs equipped with associated memory and computational elements, such as ALUs, to facilitate collective operations that employ tree-based reduction. Generally, three levels of INC reduction are achievable with data reduction collectives. At the first level, the NIC of the GPU can perform reduction operations within the GPU. At the second level, a leaf switch can execute reduction operations across all the GPU NICs coupled to it. Lastly, a spine switch can conduct reduction operations across all the leaf switches coupled to it.

The implementation of multi-layer INC reduction in switches can encounter several challenges. Leaf switches, which are typically lower-cost switches with limited resources and power budget and higher design complexity owing to implementation of most of the features-related switching functions, may find it impractical to add additional hardware such as memory or ALUs to support reduction operations. Moreover, certain reduction operations must produce consistent results on every execution, requiring a strict execution order to ensure repeatability. However, during repeatable reductions using INC, the arrival order of reduction requests from GPUs is non-deterministic. To establish a fixed execution order, data may need to be cached or collected until all participating GPUs contribute their data, after which reduction occurs in a predetermined order. Consequently, a repeatable INC tree-based reduction can only be reliably performed in a root switch, typically a spine switch, after collecting data from all GPUs across all leaf switches. Employing a multi-tier topology introduces complexities in INC tree management, leading to intricate error recovery scenarios and more challenging troubleshooting. Additionally, utilizing leaf switches for reduction necessitates setting up separate forwarding rules for INC reduction collectives, potentially causing congestion for other traffic as the reduction tree may dictate a fixed packet path regardless of congestion levels.

To alleviate the aforementioned issues, a single-tier INC is implemented in the present disclosure. To enable such a topology, the spine switch 202 may include first through third line cards 214A-214C (collectively “line cards 214”) and a fabric element 216. The first through third line cards 214A-214C may be coupled to the first through third leaf switches 204A-204C, respectively. For example, the line cards 214 are coupled to the leaf switches 204 on a one-to-one basis. The first through third line cards 214A-214C may additionally be coupled to the fabric element 216. The modular architecture of the spine switch 202 enables the single-tier INC implementation.

In additional embodiments, the fabric element 216 may be designed to handle large volumes of data traffic efficiently and reliably, often utilizing high-speed interfaces and specialized networking protocols optimized for the particular requirements of the network fabric. In modern data center architectures, the network fabrics are often built using technologies such as Ethernet, InfiniBand (“IB”), or Fiber Channel, depending on the specific requirements of the environment. Fabric elements (such as the fabric element 216) play a crucial role in enabling the scalability, performance, and flexibility of these networks, allowing organizations to meet the increasing demands of their applications and workloads. In further embodiments, a line card 214ᵢ refers to a modular hardware component of the spine switch 202. Here, subscript “i” indicates that this configuration can be present in any line cards 214A-214C. The line card 214ᵢ is responsible for handling the input and output of data packets as they pass through the spine switch 202. The line card 214ᵢ may be configured to simulate an NIC to provide access to a network. The line cards 214 and the fabric element 216 enable the data reduction operations to be executed exclusively at the spine switch 202, thereby implementing the single-tier INC.

In order to support tree reduction collective via INC, dedicated hardware resources are required in the spine switch 202 to reduce the impact of a collective operation on the regular data path. The line cards 214 are implemented as logical NICs that help setup a transport level connection (e.g., IB RC for RoCEv2) with collective group members to receive data and send back reduced data using RDMA. In still more embodiments, although not shown, the fabric element 216 may be associated with a buffer to collect and buffer data received from endpoint devices. If ‘in-place’ memory reduction is to be done (where source and destination buffers are the same), the amount of memory required is only the maximum data that one endpoint device can generate. In still further embodiments, the fabric element 216 may correspond to a dedicated ALU that can perform efficient floating point operations. The fabric element 216 may be capable of supporting 8-bit, 16-bit signed/unsigned integer and floating point operations with support for operations, for example, summation, minimum and maximum, MinLoc, MaxLoc, and bitwise OR/AND/XOR.

Every endpoint device, that joins the group, chunks (e.g., segments) the data for the collective into a predetermined chunk size and forwards the data chunks for data reduction collectives in the network. For the sake of ongoing discussion, it is assumed that at least one endpoint device coupled to each leaf switch transmits the data chunks. In other words, all three leaf switches 204, and in turn, all three line cards 214 are utilized for the data reduction collectives. The reduction operation can be repeatable or non-repeatable. Repeatable operations support is required since floating point operands are non-commutative. For example, 1.0020−(1.0020+ε)=0 is not the same as (1.0020−1.0020)−ε=−ε.

In some more embodiments, for non-repeatable reduction operations, the line cards 214 may be configured to receive a plurality of data chunks. The plurality of data chunks are received from a set of network devices (e.g., some of the endpoint devices 206) via the leaf switches 204. For example, the first line card 214A may receive data chunks generated by any of the endpoint devices 206A-206D by way of the first leaf switch 204A. Similarly, the second line card 214B may receive data chunks generated by any of the endpoint devices 206E-206G by way of the second leaf switch 204B, whereas the third line card 214C may receive data chunks generated by any of the endpoint devices 206H and 206I by way of the third leaf switch 204C.

The INC protocol data path uses a “Begin” inband message (typically a single maximum transmission unit send operation) encapsulated in a transport packet to mark the start of the RDMA data movement and aggregation operation. The line cards 214 may thus be configured to receive a plurality of start messages from the set of network devices. The plurality of start messages are configured to signal a forthcoming arrival of the plurality of data chunks. In yet more embodiments, each member endpoint device (e.g., an endpoint device of the set of network devices) may transmit a start message (e.g., a “Begin” message) followed by a barrier operation to wait on all members. Once each member endpoint device has transmitted the corresponding start message, the data chuck transmission commences.

The line cards 214 may be configured to execute a first stage of data reduction on the plurality of data chunks and obtain one or more first reduced outputs based on the execution of the first stage of data reduction on the plurality of data chunks. In still yet further embodiments, the line cards 214 may be configured to receive a plurality of end messages from the set of network devices. The plurality of end messages are received subsequent to receiving the plurality of data chunks. The plurality of end messages are configured to signal a completion of data reception. In still yet more embodiments, the one or more first reduced outputs may be obtained upon the reception of the plurality of end messages. In other words, as the plurality of end messages signal the completion of the data reception, the outputs (e.g., the one or more first reduced outputs) of the first stage of data reduction can be generated and forwarded for subsequent reduction. The fabric element 216 may be configured to receive the one or more first reduced outputs from the line cards 214. The fabric element 216 may be configured to execute a second stage of data reduction on the one or more first reduced outputs and obtain a second reduced output based on the execution of the second stage of data reduction. The non-repeatable data reduction operations are thus executed.

In the present disclosure, the spine switch 202 thus operates as a root member of a reduction tree in a single INC topology. The fabric element 216 may be configured to forward the second reduced output. The second reduced output may be forwarded to the destination endpoint devices of the data reduction collectives. In many further embodiments, the second reduced output may be forwarded by way of any of the line cards 214 and any of the leaf switches 204. For example, if the second reduced output is associated with the sixth endpoint device 206F, the fabric element 216 may forward the second reduced output to the second line card 214B, the second line card 214B may forward the second reduced output to the second leaf switch 204B, and finally, the second leaf switch 204B may forward the second reduced output to the sixth endpoint device 206F. The second line card 214B and the second leaf switch 204B act as conduits for data transfer. Thus, with single-tier INC, both the request and result can follow the same path. This helps in setting up fabric resources (e.g., using multicast trees and traffic classes) for INC reduction efficiently. In many additional embodiments, the second reduced output may be forwarded by way of different line cards of the spine switch 202 and different leaf switches.

In still yet additional embodiments, for repeatable reduction operations, the line cards 214 may be configured to receive the plurality of data chunks from the set of network devices via the leaf switches 204 and forward the plurality of data chunks to the fabric element 216. Repeatable reduction operations must produce consistent results on every execution, requiring a strict execution order. In the network, the time at which the data chunks may arrive from each endpoint device is not deterministic. In an example, repeatable operation order is the first endpoint device 206A, the seventh endpoint device 206G, the ninth endpoint device 206I, and the fourth endpoint device 206D. Here, the first and fourth endpoint devices 206A and 206D are coupled to the first leaf switch 204A, the seventh endpoint device 206G is coupled to the second leaf switch 204B, and the ninth endpoint device 206I is coupled to the third leaf switch 204C. In such a scenario, to establish a fixed execution order, data may need to be cached or collected until all participating endpoint devices contribute their data, after which reduction occurs in the predetermined order. Thus, in the present disclosure, the fabric element 216 may be configured to execute a data buffering operation until data reception from the set of network devices is complete.

The line cards 214 may be configured to receive a plurality of end messages from the set of network devices subsequent to receiving the plurality of data chunks. The completion of the data reception is signaled to the fabric element 216 by the plurality of end messages. The fabric element 216 may then be configured to receive the plurality of data chunks from the line cards 214, execute a data reduction operation on the plurality of data chunks, and obtain a reduced output based on the execution of the data reduction operation. Thus, the fabric element 216 may execute the data reduction operation upon the reception of the plurality of end messages. The data reduction operation may be executed in the predetermined order. The fabric element 216 may be configured to forward the reduced output to the endpoint devices of the data reduction collectives.

In the present disclosure, the INC hardware components (e.g., memory, ALUs, or the like) are placed in a distributed fashion in every line card of the spine switch 202 to perform reduction locally in every line card. During the data reduction phase, the line cards 214 perform the first stage of reduction. This way all the data reduction that would have conventionally been done by a leaf switch, if it were reduction capable, is now done by the corresponding spine switch line card connected to that specific leaf switch. As a result, the data reduction from all endpoint devices coupled to one leaf switch is being executed by a line card coupled to that leaf switch. Thus, the INC function that would have happened on a leaf switch is offloaded to the corresponding line card of the spine switch, with the rail-like leaf-to-spine connections aiding the process. The rail-like leaf-to-spine connections correspond to the coupling of all leaf switches (e.g., uplinks of all leaf switches) to line cards of each spine switch on a one-to-one basis.

In further additional embodiments, the start (e.g., “Begin”) message may include a field indicating whether the reduction operation is repeatable or non-repeatable, and the spine switch 202 may be configured to execute the particular type of reduction operation based on the indication in the start message.

In several embodiments, if all reduction operations are associated with a particular line card, the reduced output obtained by the first stage of data reduction may be forwarded directly to the corresponding endpoint devices. In other words, the operation of the fabric element 216 may not be required in such a scenario.

In several more embodiments, the line cards 214 may not be capable of executing data reduction operations. In such a scenario, one or more line cards can aggregate messages from multiple leaf switches belonging to the same group and send it as one aggregated message towards the fabric element 216 using the RDMA multi-receive function. The fabric element 216 may thus execute a single-stage data reduction operation.

In still additional embodiments, on-the-fly data reduction may be executed. For every data chunk, the corresponding endpoint device performs an RDMA data transfer of the data chunk to the spine switch 202, and the spine switch 202 executes the data reduction for the received data chunk and performs the RDMA of the result data back to one or more endpoint devices for that data chunk. Thus, the on-the-fly data reduction commences as and when a data chunk arrives, without needing to buffer the data. After all data chunks are completed, finally an “End” message called from all the endpoint devices completes the collective.

In numerous embodiments, an optimal network load balancing technique (e.g., packet spraying) may be implemented from the NICs of the endpoint devices to the NICs on the spine switch 202 ensuring all network bandwidth is utilized for the INC data transfer and all the endpoints have equal opportunity to send data. Since the spine switch 202 has multiple buffers for collecting data, data reordering of sprayed packets can be performed on the spine switch 202.

In numerous additional embodiments, the line cards 214 may be configured to advertise a capability parameter associated with the line cards 214. Similarly, the fabric element 216 may be configured to advertise a capability parameter associated with the fabric element 216. The amount of data that can be reduced is an INC capability parameter that is advertised to an aggregation manager associated with the single-tier INC topology. The aggregation manager may be included in the fabric to monitor and control the operations of the spine and leaf switches. For example, the aggregation manager determines whether the data reduction is to be executed in the fabric. The INC data reduction in the spine switch 202 is executed if the data being reduced is less than or equal to the capability parameter. Conversely, if the data being reduced is more than the capability parameter, the aggregation manager may be configured to reject the collective operation, and the line cards 214 may be configured to forward, via the leaf switches 204, the plurality of data chunks to the corresponding destination devices without reduction. The endpoint devices may thus have to fallback to a non-INC method of reduction using the GPU compute and using the regular GPU to GPU communication with the switches just acting like data conduits.

The fabric element 216 may be configured to advertise a repeatable reduction capacity associated with the spine switch 202. The amount of data that can be buffered (e.g., cached) in the spine switch 202 is the repeatable reduction capacity that is advertised to the aggregation manager. The INC data reduction in the spine switch 202 is executed if the data being buffered is less than or equal to the repeatable reduction capacity. Conversely, if the data being buffered is more than the repeatable reduction capacity, the aggregation manager may be configured to reject the collective operation, and the line cards 214 may be configured to forward, via the leaf switches 204, the plurality of data chunks to the corresponding destination devices without reduction. The endpoint devices may thus have to fallback to a non-INC method of reduction using the GPU compute and using the regular GPU to GPU communication with the switches just acting like data conduits.

In numerous additional embodiments, the line cards 214 or the fabric element 216 may not have the capacity to execute the data reduction operations. When the line cards 214 do not have the capacity, the line cards 214 may merely forward the data chunks to the fabric element 216 and the fabric element 216 may execute a single-stage data reduction. Conversely, when the fabric element 216 does not have the capacity, the reduced outputs may be forwarded to the destination endpoints directly without a second-stage data reduction.

The present disclosure facilitates a methodology where the reduction operation is executed exclusively in a spine switch (e.g., the spine switch 202). This is in contrast to conventional INC operations where the data reduction was executed in both leaf and spine switches. Thus, in the present disclosure, to support INC, the leaf switches 204 are not required to undergo any changes and exclusively a few spine switches are updated with necessary hardware. A smaller number of transport connections between NIC on the endpoint devices and NIC on the line cards results in more efficient data transfer and fewer data copies between memories. This avoids the need to implement NIC-to-NIC connections between leaf and spine switches and reduces complexity. The same architecture provides support for both repeatable and non-repeatable collective operations. In the present disclosure, the operations of the aggregation manager are simplified as the aggregation manager only deals with the switches in the spine layer.

A single-layer INC topology is easy to maintain and troubleshoot, with a simpler error recovery as compared to conventional INC implementations. Spine switches have higher power, real estate, and cost budget, and lesser switching function complexity, and hence, can absorb the additional INC hardware components with minimal overall impact. The modular spine switches are built for redundancy with dual switch components and no single point of failure. Hence, despite having a single-tier topology, the INC reduction tree is resilient to failures and has high availability. The overall job completion time may remain the same if INC was done in every switch in the topology since the reduction operation is not complete till data from all the endpoint devices are not processed. Additionally, as leaf switches are not utilized for reduction, the need to set up separate forwarding rules for INC reduction collectives is eliminated. Further, INC executed centrally (e.g., at the spine switch 202) conserves the overall memory required for the implementation. In some examples, the amount of INC memory required in the spine switch 202 is equal to the product of the chunk data size and the maximum number of endpoint devices 206.

The computing system 200 depicted in FIG. 2 is shown as a simplified, conceptual computing system. Those skilled in the art will understand that a computing system 200 can include a large variety of devices (e.g., endpoint devices, leaf switches, and spine switches) and be arranged in a virtually limitless number of combinations based on the desired application and available deployment environment.

Although a specific embodiment for a single-tier INC reduction using all the line cards 214 and leaf switches 204 suitable for carrying out the various steps, processes, methods, and operations described herein is discussed with respect to FIG. 2, any of a variety of systems and/or processes may be utilized in accordance with embodiments of the disclosure. For example, only endpoint devices coupled to one or two leaf switches may partake in the data reduction operations. In such a scenario, exclusively the corresponding line cards are involved in executing the first stage of data reduction. The elements depicted in FIG. 2 may also be interchangeable with other elements of FIGS. 1 and 3-8 as required to realize a particularly desired embodiment.

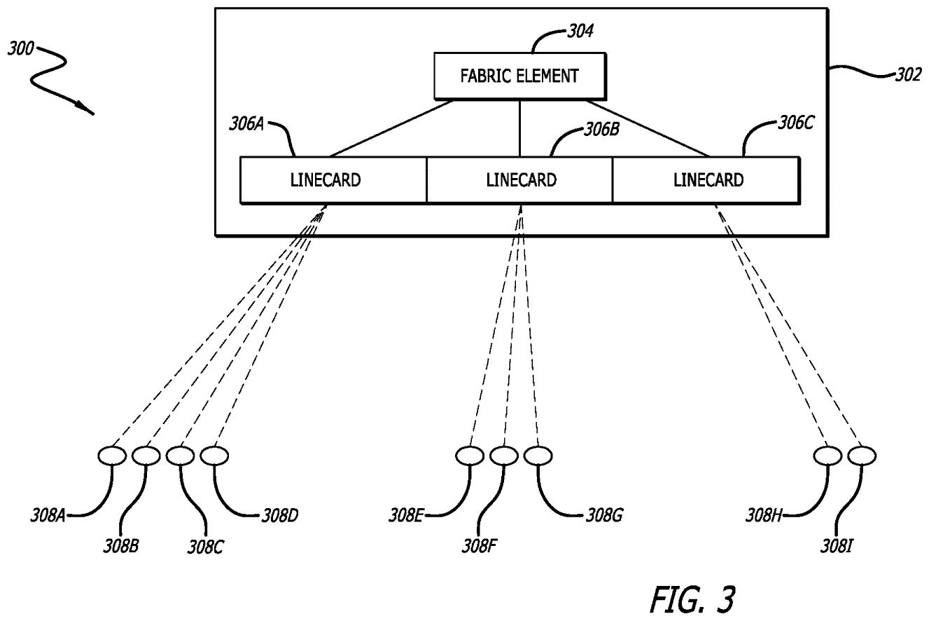

Referring to FIG. 3, a schematic block diagram of an example computing system 300 that illustrates a logical topology of the single-tier INC in accordance with various embodiments of the disclosure is shown. The computing system 300 can include a spine switch 302. In many embodiments, the spine switch 302 is a network device that interconnects and facilitates communication between the leaf switches.

The spine switch 302 may include a fabric element 304 and first through third line cards 306A-306C (collectively “line cards 306”). The modular spine switch 302 enables the single-tier INC implementation. In additional embodiments, the fabric element 304 may be designed to handle large volumes of data traffic efficiently and reliably, often utilizing high-speed interfaces and specialized networking protocols optimized for the particular requirements of the network fabric. In further embodiments, a line card 306ᵢ refers to a modular hardware component of the spine switch 302. Here, the subscript “i” indicates that this configuration can be present in any line cards 306A-306C. The line card 306ᵢ is responsible for handling the input and output of data packets as they pass through the spine switch 302. The line card 306ᵢ may be configured to simulate an NIC to provide access to a network. The line cards 306 and the fabric element 304 enable the data reduction operations to be executed exclusively at the spine switch 302, thereby implementing the single-tier INC.

The computing system 300 may further include first through ninth endpoint devices 308A-308I (collectively “endpoint devices 308”). The endpoint devices 308 can include any communication devices, such as computers, servers, switches, routers, GPUs, etc. Endpoint devices (such as the endpoint devices 308) that want to perform a collective operation, create and join a group, with every endpoint device being assigned a unique ID.

In several embodiments, single-tier INC topology is implemented for non-repeatable and repeatable reduction operations. The line cards 306 may be configured to receive a plurality of data chunks from a set of network devices (e.g., some of the endpoint devices 308) via leaf switches. In still yet more embodiments, for non-repeatable reduction operations, the line cards 306 may be configured to execute a first stage of data reduction on the plurality of data chunks, obtain one or more first reduced outputs, and forward the one or more first reduced outputs to the fabric element 304. The fabric element 304 may be configured to execute a second stage of data reduction on the one or more first reduced outputs, obtain a second reduced output, and forward the second reduced output to the destination endpoint devices by way of any of the line cards 306 and any of the leaf switches. For repeatable reduction operations, the line cards 306 may be configured to forward the received plurality of data chunks to the fabric element 304. The fabric element 304 may be configured to execute a data buffering operation until data reception from the set of network devices is complete. The fabric element 304 may be configured to execute a single-stage data reduction operation on the plurality of data chunks, obtain a reduced output, and forward the reduced output to the destination endpoint devices by way of any of the line cards 306 and any of the leaf switches.

In the present disclosure, the spine switch 302 thus operates as a root member of a reduction tree in a single-tier INC topology. Further, in both non-repeatable and repeatable reduction operations, the leaf switches do not execute any reduction operations and only act as conduits for the data movement. During the data reduction phase, the line cards 306 performs the first stage of reduction. This way all the data reduction that would have conventionally been done by a leaf switch, if it were reduction capable, is now done by the corresponding spine switch line card connected to that specific leaf switch. Thus, the INC function that would have happened on a leaf switch is offloaded to the corresponding line card of the spine switch 302.

Thus, as illustrated in FIG. 3, the logical topology of the single-tier INC does not illustrate any leaf switches, with the endpoint devices 308 directly coupled to the line cards 306. The dotted lines indicate NIC-NIC connections for INC. In numerous embodiments, an INC orchestrator called an aggregation manager may be configured to discover the network topology, determine the endpoint devices partaking in the INC, and create a logical INC reduction tree depending on the capability of switches and the participating endpoint devices. This logical tree is overlaid on the physical network switch topology for performing the collective operation. A single-tier INC tree is cost-effective, simple, and efficient.

To summarize, in a spine-leaf topology, only the modular spine switch is capable of INC. The aggregation manager creates a simplified logical view of the reduction tree with only the spine switch as the member and the root of the logical reduction tree. The leaf switches only act as a conduit towards the spine switch to carry data for reduction, but do not participate in the reduction. This results in an optimized single-tier reduction tree that simplifies INC functionality and the aggregation manager operation.

The computing system 300 depicted in FIG. 3 is shown as a simplified, conceptual computing system. Those skilled in the art will understand that a computing system 300 can include a large variety of devices and be arranged in a virtually limitless number of combinations based on the desired application and available deployment environment.

Although a specific embodiment for a single-tier INC reduction using all endpoint devices 308 suitable for carrying out the various steps, processes, methods, and operations described herein is discussed with respect to FIG. 3, any of a variety of systems and/or processes may be utilized in accordance with embodiments of the disclosure. For example, only some endpoint devices may be partaking in the reduction collectives. In such a scenario, the logical topology may include only the participating endpoint devices coupled to the spine switch 302. The elements depicted in FIG. 3 may also be interchangeable with other elements of FIGS. 1, 2, and 4-8 as required to realize a particularly desired embodiment.

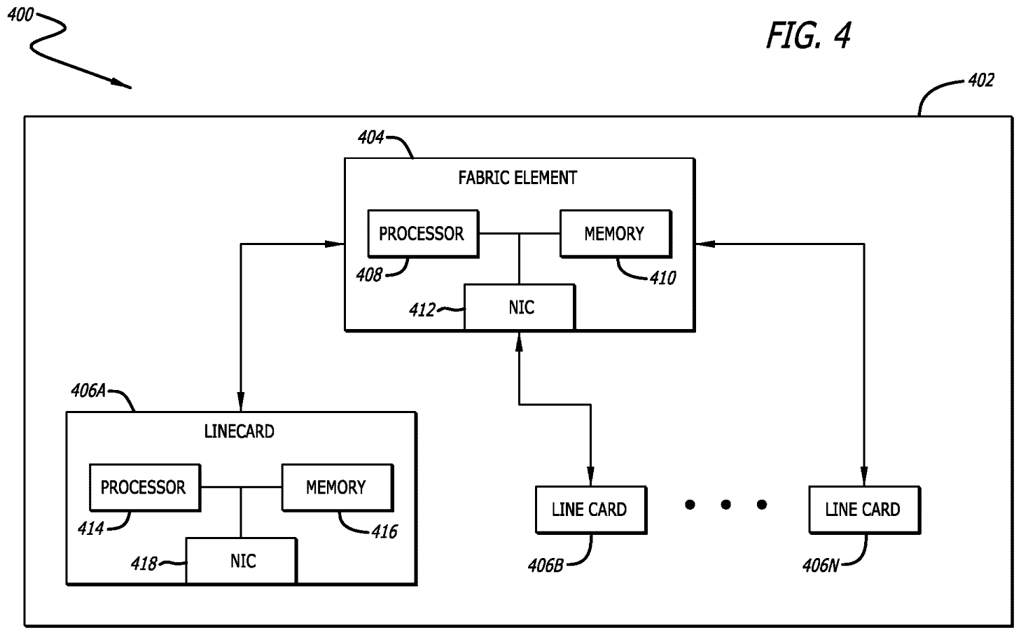

Referring to FIG. 4, a schematic block diagram 400 of a spine switch 402 in accordance with various embodiments of the disclosure is shown. In many embodiments, the spine switch 402 is a network device that interconnects and facilitates communication between leaf switches. The spine switch 402 may be configured to route traffic between the different leaf switches. The embodiments depicted in FIG. 4 may show the spine switch 402 including a fabric element 404 and line cards 406A, 406B, . . . 406N (collectively “line cards 406”). The modular architecture of the spine switch 402 enables the single-tier INC implementation.

In additional embodiments, the fabric element 404 may be designed to handle large volumes of data traffic efficiently and reliably, often utilizing high-speed interfaces and specialized networking protocols optimized for the particular requirements of the network fabric. In further embodiments, a line card 406ᵢ refers to a modular hardware component of the spine switch 402. Here, the subscript “i” indicates that this configuration can be present in any line cards 406A to 406N. The line card 406ᵢ is responsible for handling the input and output of data packets as they pass through the spine switch 402. The line card 406ᵢ may be configured to simulate an NIC to provide access to a network. The line cards 406 and the fabric element 404 enable the data reduction operations to be executed exclusively at the spine switch 402, thereby implementing the single-tier INC.

In several embodiments, single-tier INC topology is implemented for non-repeatable and repeatable reduction operations. The line cards 406 may be configured to receive a plurality of data chunks from a set of network devices via leaf switches. In still yet more embodiments, for non-repeatable reduction operations, the line cards 406 may be configured to execute a first stage of data reduction on the plurality of data chunks, obtain one or more first reduced outputs, and forward the one or more first reduced outputs to the fabric element 404. The fabric element 404 may be configured to execute a second stage of data reduction on the one or more first reduced outputs, obtain a second reduced output, and forward the second reduced output to the destination endpoint devices by way of any of the line cards 406 and any of the leaf switches. For repeatable reduction operations, the line cards 406 may be configured to forward the received plurality of data chunks to the fabric element 404. The fabric element 404 may be configured to execute a data buffering operation until data reception from the set of network devices is complete. The fabric element 404 may be configured to execute a single-stage data reduction operation on the plurality of data chunks, obtain a reduced output, and forward the reduced output to the destination endpoint devices by way of any of the line cards 406 and any of the leaf switches.

To enable the aforementioned operations, the fabric element 404 may include a processor 408, a memory 410, and an NIC 412 coupled to each other via a communication bus, whereas a line card 406ᵢ may include a processor 414, a memory 416, and an NIC 418 coupled to each other via a communication bus. Here, the subscript “i” indicates that this configuration can be present in any of the line cards 406A to 406N. In FIG. 4, an exploded view of only one line card 406A is shown for illustrative purposes. In numerous additional embodiments, each of the fabric element 404 and the line card 406ᵢ may further include an ALU co-processor for executing floating point arithmetic operations.

The processor 408 can be a standard CPU that performs arithmetic and logical operations necessary for the operation of the fabric element 404. The processor 408 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, ALUs, floating-point units, and the like. For example, the processor 408 may be configured to execute the data buffering and data reduction operations.

The memory 410 may be communicatively coupled to the processor 408. Examples of the memory 410 may include a RAM, a read-only memory (ROM), an erasable programmable ROM (“EPROM”), an electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion. The memory 410 may be configured to store various instructions to be executed by the processor 408. The memory 410 may also be configured to store other application components necessary for the operation of the fabric element 404. The memory 410 may include a set of instructions stored within a non-volatile memory that, when executed by the processor 408 can carry out various steps.

The NIC 412 may include a gigabit Ethernet adapter or any similar component that may couple the fabric element 404 to other devices, for example, one of the line cards 406. The NIC 412 can provide the necessary interface (e.g., input ports and output ports) to couple the fabric element 404 to one of the line cards 406. The NIC 412 may thus be configured to provide access to a network. The NIC 412 can be configured to handle the transmission and reception of packets, implementing protocols such as the RoCEv2 protocol to ensure compatibility and interoperability within the network. In several embodiments, the NIC 412 may receive the data chunks from and forward the reduction result to the line cards 406.

The processor 414 can be a standard CPU that performs arithmetic and logical operations necessary for the operation of the line card 406ᵢ. The processor 414 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, ALUs, floating-point units, and the like. For example, the processor 414 may be configured to execute a stage of data reduction.

The memory 416 may be communicatively coupled to the processor 414. Examples of the memory 416 may include a RAM, a ROM, an EPROM, an EEPROM, a flash memory or other solid-state memory technology, CDROM, DVD, HD-DVD, BLU-RAY, or other optical storage, magnetic cassettes, magnetic tape, magnetic disk storage or other magnetic storage devices, or any other medium that can be used to store the desired information in a non-transitory fashion. The memory 416 may be configured to store various instructions to be executed by the processor 414. The memory 416 may also be configured to store other application components necessary for the operation of the line card 406ᵢ. The memory 416 may include a set of instructions stored within a non-volatile memory that, when executed by the processor 414 can carry out various steps.

The NIC 418 may include a gigabit Ethernet adapter or any similar component that may couple the line card 406ᵢ to other devices, for example, one of the fabric element 404. The NIC 418 can provide the necessary interface (e.g., input ports and output ports) to couple the line card 406ᵢ to the fabric element 404. The NIC 418 may thus be configured to provide access to a network. The NIC 418 can be configured to handle the transmission and reception of packets, implementing protocols such as the RoCEv2 protocol to ensure compatibility and interoperability within the network. In several more embodiments, the NIC 418 may receive the data chunks from endpoint devices. In several additional embodiments, the NIC 418 may forward, to the fabric element 404 (e.g., the NIC 412), the received data chunks or a set of outputs obtained by executing a stage of data reduction on the received data chunks. In further additional embodiments, the NIC 418 may receive the reduction result from the fabric element 404 (e.g., the NIC 412) and forward the reduction result to corresponding endpoint devices.

Although a specific embodiment for a spine switch suitable for carrying out the various steps, processes, methods, and operations described herein is discussed with respect to FIG. 4, any of a variety of systems and/or processes may be utilized in accordance with embodiments of the disclosure. For example, line cards may not be capable of executing data reduction operations. In such a scenario, one or more line cards can aggregate messages from multiple leaf switches belonging to the same group and send it as one aggregated message towards the fabric element 404 using the RDMA multi-receive function. The fabric element 404 may thus execute a single-stage data reduction operation. The elements depicted in FIG. 4 may also be interchangeable with other elements of FIGS. 1-3, and 5-8 as required to realize a particularly desired embodiment.

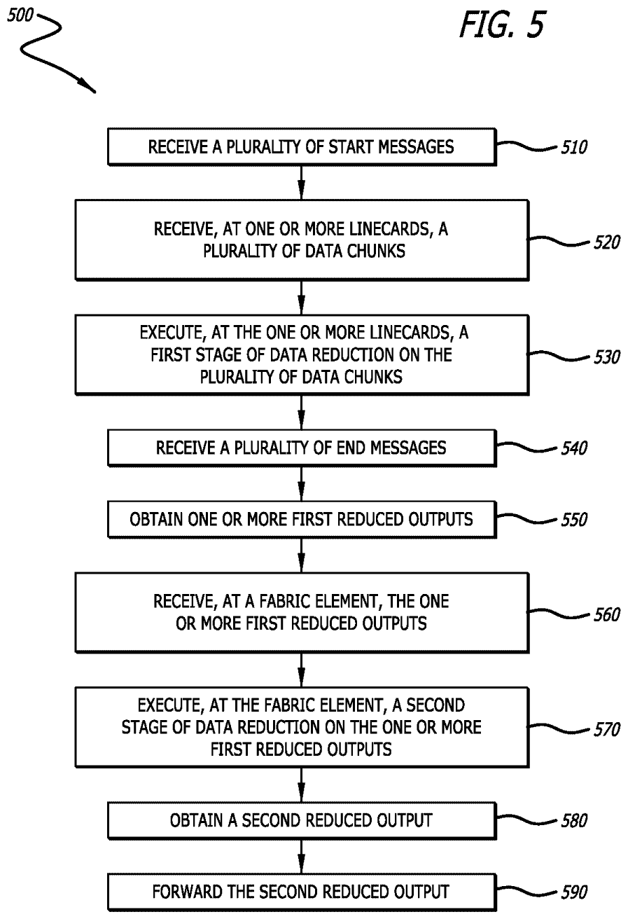

Referring to FIG. 5, a process 500 for implementing a non-repeatable reduction operation in single-tier INC in accordance with various embodiments of the disclosure is shown. In many embodiments, the process 500 may receive a plurality of start messages (block 510). The plurality of start (e.g., “Begin”) messages may be received from a set of network devices (e.g., GPUs). The plurality of start messages are configured to signal a forthcoming arrival of data chunks. In yet more embodiments, a start message may be transmitted by each member endpoint device (e.g., an endpoint device of the set of network devices). The start message may be followed by a barrier operation to wait on all members. Once each member endpoint device has transmitted the corresponding start message, the data chunk transmission commences.

In a number of embodiments, the process 500 may receive, at one or more line cards, a plurality of data chunks (block 520). Every member endpoint device chunks the data for the collective into a predetermined chunk size and forwards the data chunks for data reduction collectives in the network. The plurality of data chunks may be received at the one or more line cards via one or more leaf switches, respectively. The line cards and the leaf switches are coupled on a one-to-one basis.

In a variety of embodiments, the process 500 may execute, at the one or more line cards, a first stage of data reduction on the plurality of data chunks (block 530). In numerous embodiments, the process 500 may receive a plurality of end messages (block 540). The plurality of end messages may be received from the set of network devices via the leaf switches. The plurality of end messages are received subsequent to receiving the plurality of data chunks, and are configured to signal a completion of data reception. In more embodiments, the process 500 may obtain one or more first reduced outputs (block 550). The one or more first reduced outputs may be obtained upon the reception of the plurality of end messages and based on the first stage of data reduction executed on the plurality of data chunks.

In additional embodiments, the process 500 may receive, at a fabric element, the one or more first reduced outputs (block 560). The one or more first reduced outputs may be received from the one or more line cards. In further embodiments, the process 500 may execute, at the fabric element, a second stage of data reduction on the one or more first reduced outputs (block 570). In still more embodiments, the process 500 may obtain a second reduced output (block 580). The second reduced output may be obtained based on the execution of the second stage of data reduction on the one or more first reduced outputs. The data reduction operations are thus executed. Such reduction operations are referred to as non-repeatable reduction operations.

In still further embodiments, the process 500 may forward the second reduced output (block 590). The second reduced output may be forwarded to the endpoint devices of the data reduction collectives. In still additional embodiments, the second reduced output may be forwarded by way of any of the line cards and any of the leaf switches. With a single-tier INC, both the request and result can follow the same path. This helps in setting up fabric resources (e.g., using multicast trees and traffic classes) for INC reduction efficiently.

Although a specific embodiment for non-readable reduction operations for carrying out the various steps, processes, methods, and operations described herein is discussed with respect to FIG. 5, any of a variety of systems and/or processes may be utilized in accordance with embodiments of the disclosure. For example, repeatable reduction operations may be executed. The elements depicted in FIG. 5 may also be interchangeable with other elements of FIGS. 1-4 and 6-8 as required to realize a particularly desired embodiment.

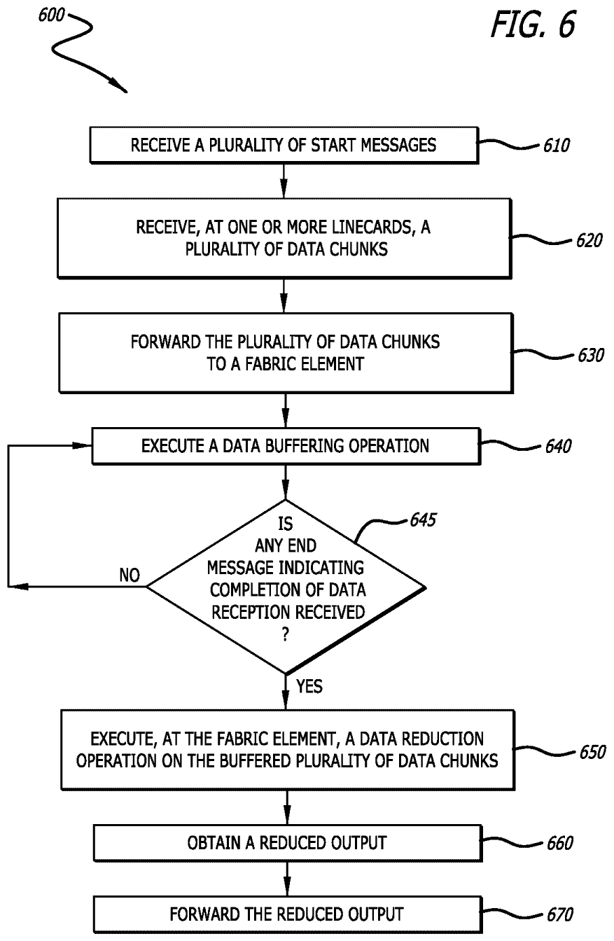

Referring to FIG. 6, a process 600 for implementing a repeatable reduction operation in single-tier INC in accordance with various embodiments of the disclosure is shown. In many embodiments, the process 600 may receive a plurality of start messages (block 610). The plurality of start (e.g., “Begin”) messages may be received from a set of network devices (e.g., GPUs). The plurality of start messages are configured to signal a forthcoming arrival of data chunks.

In a number of embodiments, the process 600 may receive, at one or more line cards, a plurality of data chunks (block 620). Every member endpoint device chunks the data for the collective into a predetermined chunk size and forwards the data chunks for data reduction collectives in the network. The plurality of data chunks may be received at the one or more line cards via one or more leaf switches, respectively. The line cards and the leaf switches are coupled on a one-to-one basis.

In a variety of embodiments, the process 600 may forward the plurality of data chunks to a fabric element (block 630). In numerous embodiments, the process 600 may execute a data buffering operation (block 640). Repeatable reduction operations must produce consistent results on every execution, requiring a strict execution order. In the network, the time at which the data chunks may arrive from each endpoint device is not deterministic. Thus, to establish a fixed execution order, data may need to be cached or collected until all participating endpoint devices contribute their data, after which reduction occurs in a predetermined order.

In more embodiments, the process 600 may determine if any end message indicating completion of data reception is received (block 645). In additional embodiments, in response to an end message, the process 600 may continue to execute the data buffering operation. Thus, in the present disclosure, the data buffering operation is executed until data reception is complete.

However, in further embodiments, in response to an end message indicating completion of data reception being received, the process 600 may execute, at the fabric element, a data reduction operation on the buffered plurality of data chunks (block 650). The data reduction operation is executed on the buffered plurality of data chunks in the predetermined order. In still more embodiments, the process 600 may obtain a reduced output (block 660). The reduced output may be obtained based on the execution of the data reduction operation on the buffered plurality of data chunks in the predetermined order. The repeatable data reduction operations are thus executed.

In still further embodiments, the process 600 may forward the reduced output (block 670). The reduced output may be forwarded to the endpoint devices of the data reduction collectives. In still additional embodiments, the reduced output may be forwarded by way of any of the line cards and any of the leaf switches.

Although a specific embodiment for data reduction operations for carrying out the various steps, processes, methods, and operations described herein is discussed with respect to FIG. 6, any of a variety of systems and/or processes may be utilized in accordance with embodiments of the disclosure. For example, the data reduction operations may be executed based on the capability and capacity of the network. The elements depicted in FIG. 6 may also be interchangeable with other elements of FIGS. 1-5, 7, and 8 as required to realize a particularly desired embodiment.

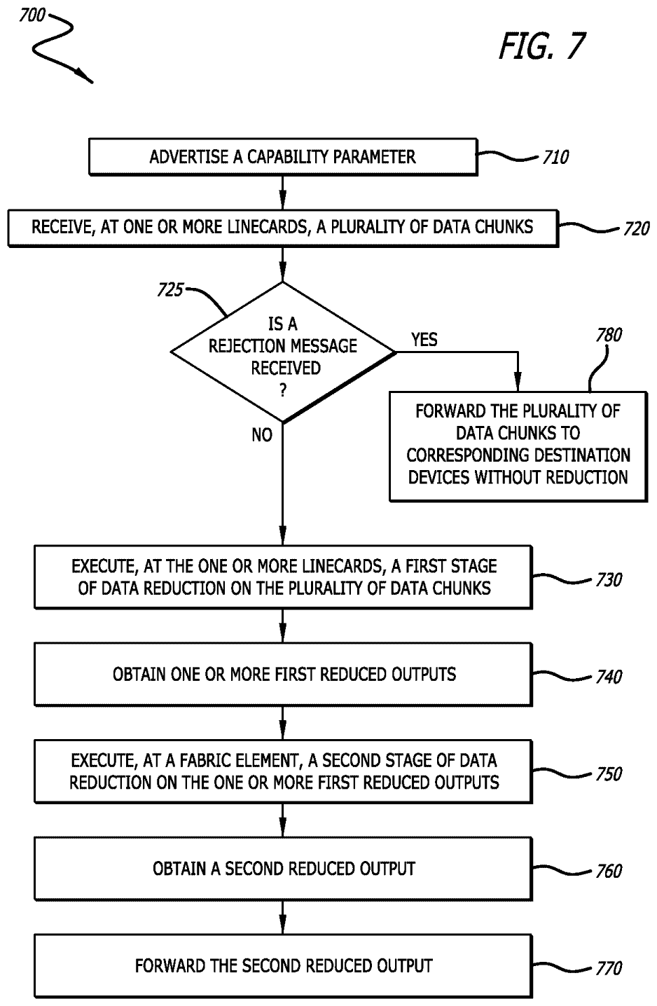

Referring to FIG. 7, a process 700 for implementing a reduction operation in a spine switch in accordance with various embodiments of the disclosure is shown. In many embodiments, the process 700 may advertise a capability parameter (block 710). The capability parameter may be associated with line cards or a fabric element. The amount of data that can be reduced is a capability parameter that is advertised to an aggregation manager associated with the single-tier INC topology.

In a number of embodiments, the process 700 may receive, at one or more line cards, a plurality of data chunks (block 720). Every member endpoint device chunks the data for the collective into a predetermined chunk size and forwards the data chunks for data reduction collectives in the network. The plurality of data chunks may be received at the one or more line cards via one or more leaf switches, respectively. The line cards and the leaf switches are coupled on a one-to-one basis.

In a variety of embodiments, the process 700 may determine whether a rejection message is received (block 725). In numerous embodiments, in response to no rejection message being received from the aggregation manager, the process 700 may execute, at the one or more line cards, a first stage of data reduction on the plurality of data chunks (block 730). In numerous additional embodiments, if the data being reduced is less than the capability parameter, the aggregation manager may not reject the collective operation. In more embodiments, the process 700 may obtain one or more first reduced outputs (block 740). The one or more first reduced outputs may be obtained based on the first stage of data reduction executed on the plurality of data chunks.

In additional embodiments, the process 700 may execute, at the fabric element, a second stage of data reduction on the one or more first reduced outputs (block 750). In further embodiments, the process 700 may obtain a second reduced output (block 760). The second reduced output may be obtained based on the execution of the second stage of data reduction on the one or more first reduced outputs. In still more embodiments, the process 700 may forward the second reduced output (block 770). The second reduced output may be forwarded to the endpoint devices of the data reduction collectives.

However, in still further embodiments, in response to a rejection message being received from the aggregation manager, the process 700 may forward the plurality of data chunks to corresponding destination devices without reduction. In still additional embodiments, if the data being reduced is more than the capability parameter, the aggregation manager may be configured to reject the collective operation. The endpoint devices may thus have to fall back to a non-INC method of reduction using the GPU compute and using the regular GPU to GPU communication with the switches just acting like data conduits.

Although a specific embodiment for capability-based non-repeatable data reduction operation suitable for carrying out the various steps, processes, methods, and operations described herein is discussed with respect to FIG. 7, any of a variety of systems and/or processes may be utilized in accordance with embodiments of the disclosure. For example, the repeatable data reduction operations may also be executed based on the capability parameter of the line cards and/or fabric element. The elements depicted in FIG. 7 may also be interchangeable with other elements of FIGS. 1-6 and 8 as required to realize a particularly desired embodiment.

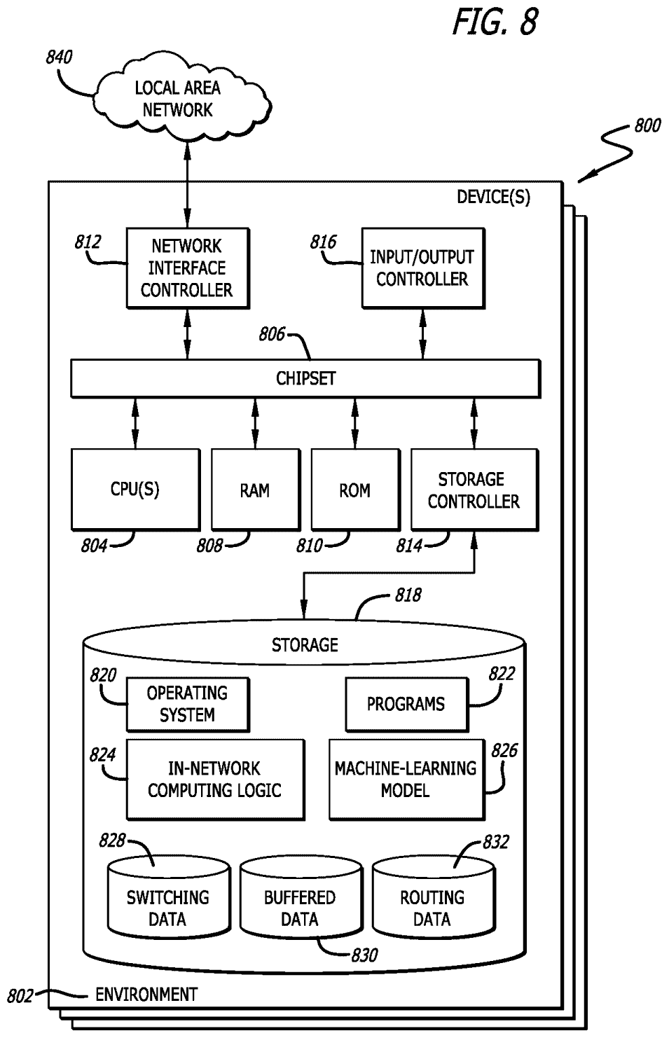

Referring to FIG. 8, a conceptual block diagram for one or more devices 800 capable of executing components and logic for implementing the functionality and embodiments described above is shown. The embodiment of the conceptual block diagram depicted in FIG. 8 can illustrate a conventional server computer, workstation, desktop computer, laptop, tablet, network appliance, e-reader, smartphone, or other computing device, and can be utilized to execute any of the application and/or logic components presented herein. The device 800 may, in some examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, CPUs can be configured to operate in conjunction with a chipset 806. The processor(s) 804 can be standard programmable CPUs that perform arithmetic and logical operations necessary for the operation of the device 800.

In additional embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, ALUs, floating-point units, and the like.

In numerous additional embodiments, the chipset 806 may provide an interface between the processor(s) 804 and the remainder of the components and devices within the environment 802. The chipset 806 can provide an interface to a RAM 808, which can be used as the main memory in the device 800 in numerous embodiments. The chipset 806 can further be configured to provide an interface to a computer-readable storage medium such as a ROM 810 or Non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Different embodiments of the device 800 can be configured to operate in a networked environment using logical connections to remote computing devices and computer systems through a network, such as the network 840. The chipset 806 can include functionality for providing network connectivity through an NIC 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for example, store an operating system 820, applications 822, and data 828, 830, and 832, which are described in greater detail below. The storage 818 can be connected to the environment 802 through a storage controller 814 connected to the chipset 806. In numerous additional embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

For example, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, a RAM, a ROM, an EPROM, an EEPROM, flash memory or other solid-state memory technology, CD-ROM, DVD, HD-DVD, BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In various embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In numerous embodiments, the device 800 has access to computer-readable storage media storing computer-executable instructions which, when executed by the device 800, perform the various processes described above with regard to FIGS. 1-7. In more embodiments, the device 800 can also include computer-readable storage media having instructions stored thereupon for performing any of the other computer-implemented operations described herein.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8, and can include other components that are not explicitly shown in FIG. 8, or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more VMs running on the device 800 to perform functions described herein. The virtualization layer may generally support a virtual resource that performs at least a portion of the techniques described herein.

In many embodiments, the device 800 can include an INC logic 824 that can be configured to perform one or more of the various steps, processes, operations, and/or other methods that are described above. Often, the INC logic 824 can be a set of instructions stored within a non-volatile memory that, when executed by the processor(s)/controller(s) 804 can carry out these steps, etc. In numerous embodiments, the INC logic 824 may be a client application that resides on a network-connected device, such as, but not limited to, a server, switch, personal or mobile computing device, or an access point. In numerous additional embodiments, the INC logic 824 can execute data reduction operations on data chunks generated by endpoint devices (e.g., GPUs). The data reduction operations may be executed in a single stage or multiple stages. In numerous embodiments, the INC logic 824 may forward the reduction result to the relevant GPUs. The INC logic 824 may thus be able to alleviate inter-GPU traffic by executing data reduction collectives in the network.

In a number of embodiments, the storage 818 can include switching data 828. The switching data 828 involves forwarding frames within the same network based on media access control (“MAC”) addresses, typically within a local area network. The switching data 828 can include information, for example, MAC address tables. When a packet arrives at a switch, the switch checks the MAC address table to determine the outgoing port for the packet based on the destination MAC address.

In various embodiments, the storage 818 can include buffered data 830. In several embodiments, the buffered data 830 can comprise data chunks arriving from endpoint devices (e.g., GPUs). Repeatable reduction operations must produce consistent results on every execution, requiring a strict execution order. In the network, the time at which the data chunks may arrive from each endpoint device is not deterministic. Thus, to establish a fixed execution order, data may need to be cached or collected until all participating endpoint devices contribute their data, after which reduction occurs in a predetermined order. Thus, in the present disclosure, a data buffering operation is executed until data reception from all member GPUs is complete.

In a number of embodiments, the storage 818 can include routing data 832. In numerous embodiments, routing data 832 can include information, for example, routing tables. The routing table may contain various entries that map destination IP addresses to the next hop or outgoing ports. Routing tables enable the device 800 to make packet forwarding decisions. The MAC address table is an example of a routing table. MAC address table may include destination MAC addresses mapped to corresponding switch ports. The routing data 832 may further store a mapping between IP addresses and MAC addresses within a network. Such mapping may be utilized to translate IP addresses to MAC addresses for proper forwarding of packets.

Finally, in many embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826. The ML model 826 may be configured to learn capability patterns of line cards and fabric elements based on data related to historical advertisements and predict the capability parameter at any time instance. Such predictions may be utilized, in the absence of any advertisement from the line cards and the fabric element, to determine whether the collective operations are to be rejected.

The ML model(s) 826 can be configured to generate inferences to make predictions or draw conclusions from data. An inference can be considered the output of a process of applying a model to new data. This can occur by learning from data and using that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although a specific embodiment for a device suitable for configuration with an INC logic for carrying out the various steps, processes, methods, and operations described herein is discussed with respect to FIG. 8, any of a variety of systems and/or processes may be utilized in accordance with embodiments of the disclosure. For example, the device 800 may be in a virtual environment such as a cloud-based network administration suite, or it may be distributed across a variety of network devices or switches. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor;
a plurality of line cards, wherein one or more line cards of the plurality of line cards are configured to:
receive a plurality of data chunks;
execute a first stage of data reduction on the plurality of data chunks; and
obtain one or more first reduced outputs based on the execution of the first stage of data reduction; and
a fabric element coupled to the plurality of line cards, wherein the fabric element is configured to:
receive the one or more first reduced outputs;
execute a second stage of data reduction on the one or more first reduced outputs;
obtain a second reduced output based on the execution of the second stage of data reduction; and
forward the second reduced output.

2. The device of claim 1, wherein the plurality of data chunks are received from a set of network devices.

3. The device of claim 2, wherein the one or more line cards are further configured to receive a plurality of start messages from the set of network devices.

4. The device of claim 3, wherein the plurality of start messages are configured to signal a forthcoming arrival of the plurality of data chunks.

5. The device of claim 2, wherein the one or more line cards are further configured to receive a plurality of end messages from the set of network devices.

6. The device of claim 5, wherein the plurality of end messages are received subsequent to receiving the plurality of data chunks.

7. The device of claim 6, wherein the plurality of end messages are configured to signal a completion of data reception.

8. The device of claim 2, wherein the plurality of data chunks are received from the set of network devices via one or more leaf switches.

9. The device of claim 1, wherein the plurality of line cards are coupled to a set of leaf switches.

10. The device of claim 9, wherein the plurality of line cards are coupled to the set of leaf switches on a one-to-one basis.

11. The device of claim 1, wherein the device operates as a root member of a reduction tree in a single-tier in-network computing topology.

12. The device of claim 1, wherein a line card of the plurality of line cards is configured to simulate a network interface controller to provide access to a network.

13. The device of claim 1, wherein at least one of the plurality of line cards or the fabric element is configured to advertise a capability parameter associated with at least one of the plurality of line cards or the fabric element.

14. A device, comprising:
a processor;
a memory communicatively coupled to the processor;
a plurality of line cards, wherein one or more line cards of the plurality of line cards are configured to:
receive a plurality of data chunks; and
forward the plurality of data chunks; and
a fabric element coupled to the plurality of line cards, wherein the fabric element is configured to:
receive, from the one or more line cards, the plurality of data chunks;
execute a data reduction operation on the plurality of data chunks;
obtain a reduced output based on the execution of the data reduction operation; and
forward the reduced output.

15. The device of claim 14, wherein the fabric element is further configured to execute a data buffering operation until data reception from a set of network devices is complete.

16. The device of claim 15, wherein the one or more line cards are further configured to receive a plurality of end messages from the set of network devices subsequent to receiving the plurality of data chunks.

17. The device of claim 16, wherein the completion of the data reception is signaled to the fabric element by the plurality of end messages.

18. A method, comprising:
receiving a plurality of data chunks;
executing a first stage of data reduction on the plurality of data chunks to obtain one or more first reduced outputs;
executing a second stage of data reduction on the one or more first reduced outputs to obtain a second reduced output; and
forwarding the second reduced output.

19. The method of claim 18, wherein the first stage of data reduction and the second stage of data reduction are executed in a modular spine switch.

20. The method of claim 19, wherein the modular spine switch is a root member of a reduction tree in a single-tier in-network computing topology.
